(19) United States
(12) Patent Application Publication
(10) Pub. No.: US 2013/0339142 A1
(43) Pub. Date: Dec. 19, 2013

(54) ONLINE CONTENT BASED ON INTERNET ACTIVITY

(71) Applicant: Philip Hewinson, London (GB)

(72) Inventor: Philip Hewinson, London (GB)

(73) Assignee: Google Inc.

(21) Appl. No.: 13/526,341

(22) Filed: Jun. 18, 2012

(51) Int. Cl. G06Q 30/02

(52) U.S. Cl. 705/14.51; 705/14.49

(57) ABSTRACT

Systems, methods, and computer-readable media that may be used to provide advertisements to a second user based on the first user's online interactions. One method receiving, at an advertising system comprising at least one server computing system, web pages that were visited by a first user that is connected to a second user on an online social network. The method further includes determining, using the advertising system, an advertisement to be provided to a second user based on the web pages that were visited by the first user. The method further includes providing, using the advertising system, the advertisement for presentation to the second user.

### BACKGROUND

The Internet provides access to a wide variety of content. For instance, images, audio, video, and web pages for many different topics are accessible through the Internet. The system provides an opportunity for content providers to present content to users. Content can be served, for example in as a web page, image or video, and/or in an advertisement slot of a pop-up window or other overlay.

Many Internet content providing methods customize content based on information about the user who is viewing the content. For example, characteristics and/or interests of the viewing user may be used to choose content that is likely to capture the attention of the viewing user. Such systems fail to account for opportunities that may exist in the interaction of the user with other individuals on the Internet.

### SUMMARY

One implementation of the disclosure relates to systems, methods, and computer-readable media that may be used to provide content to a second user based on the first user's online interactions. One method includes receiving, at an advertising system comprising at least one server computing system, web pages that were visited by a first user that is connected to a second user on an online social network or based on a relationship between the users. The method further includes, determining using the advertising system, content to be provided to a second user based on the web pages that were visited by the first user. The method further includes providing, using the advertising system, content or advertisement for presentation to the second user.

Another implementation of the disclosure relates to a system including at least one computing device operably coupled to at least one memory and configured to receive web pages that were visited by a first user that is connected to a second user on an online social network. The system determines content to be provided to a second user based on the web pages that were visited by the first user and the system provides the content for presentation to the second user.

Another implementation of the disclosure relates to a computer-readable medium having instructions stored thereon that, when executed by a processor, cause the processor to perform operations including receiving web pages that were visited by a first user that is connected to a second user on an online social network. The computer-readable medium includes determining content or advertisement to be provided to a second user based on the web pages that were visited by the first user. The computer-readable medium includes providing the advertisement for presentation to the second user.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an advertisement system and associated environment according to an illustrative implementation.

FIG. 2 is a flow diagram of a process for providing content based on the interaction of a user online with representations of one or more other users according to an illustrative implementation.

FIG. 3 is an example screen display that may be provided to a user on an online social networking website where the co-user may assemble a gift list.

FIG. 4 is an example screen display that may be provided to a user when the user performs a search and gift ideas are suggested to the user for the other users that are connected to the user.

FIG. 5 is a flow diagram of a process for determining the gift list for a user based on the searches performed by the user.

FIG. 6 is a block diagram of an example computing system according to an illustrative implementation.

### DETAILED DESCRIPTION

Referring generally to the Figures, various illustrative systems and methods are provided that may be used to generate content based on a user's online interactions with other people. Various implementations are directed to providing, content to a user based on another user's Internet activity. Internet activity may include various tasks such as searching, indicating a preference or approval of an item or service, or creating a list of liked items or services or wish list or gift lists. The systems and method discussed below are directed to displaying content on web pages that are used by one user based on the characteristics or preferences of another user, when one user is looking for a gift for another user. The content, that includes advertisements, may be based on characteristics of the other users, and/or the content may be based on the online representations of another user. In some instances, the content may be suggestions for gifts from a user to another user. The content may be based on any type of Internet activity of the other user, such as viewing an online community post or profile of other users, interactions with the other user (e.g. E-mail or messages). A user may be interacting online live (e.g., in real-time) with other users (e.g., via chat) or may be interacting with an online representation of other users and not interacting live with other users (e.g., viewing a profile of other users). The ads may be based on information (e.g., public information) about the other user and/or information (e.g., public and/or semi-public information) about the other user, such as demographic information, online social network profile information, and other types of information. In some implementations, the ads may be based on non-public information about the other user that the other user has chosen to make visible to the user. In some implementations, the ads may be based on available information about the interaction of the users, such as how frequently the users interact with one another. In some implementations, the ads may be linked to gift-related special occasions (e.g., birthdays, anniversaries, national or religious holidays etc.). In some implementations, the interaction may not necessarily be 1:1; for example, in one implementation, a user may be viewing a picture including a group of the user's teammates on an athletic team or a small group of friends from school, a circle of friends or co-workers, or other defined groups.

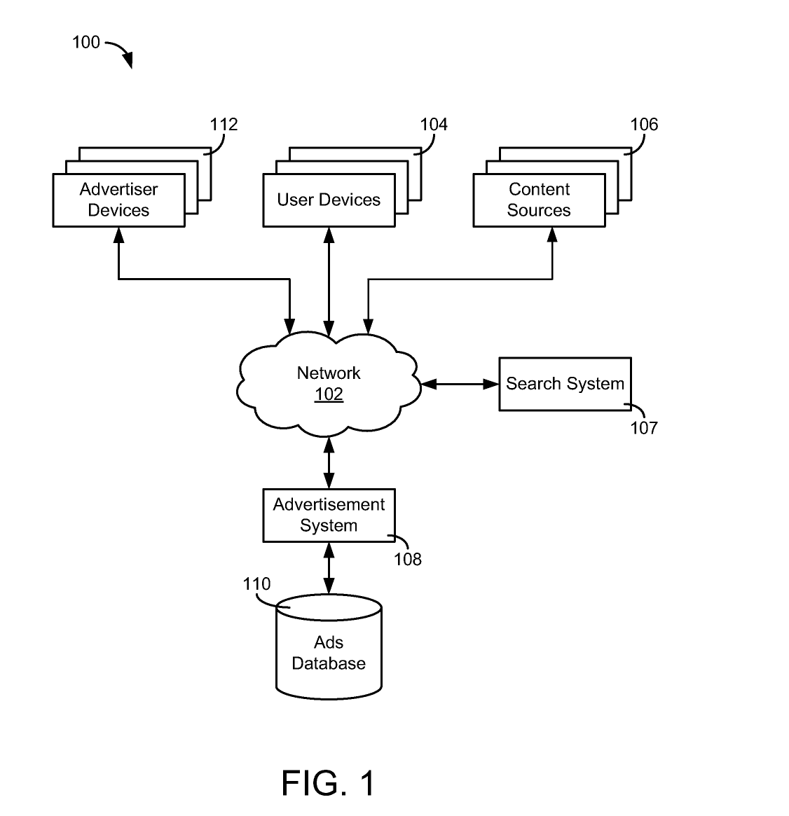

FIG. 1 illustrates a block diagram of an example advertisement system 108 and associated environment 100 according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. Various types of content accessed through user devices 104 may include content designed to encourage users of user devices 104 to purchase certain products and/or services and/or to perform other actions that a content provider seeks to cause users to perform.

User devices 104 may be any type of computing device (e.g., having a processor and memory or other type of computer-readable medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 may be designed to use various types of software and/or operating systems. In various illustrative implementations, user devices 104 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 may be configured to receive data from various sources using a network 102. In some implementations, network 102 may comprise a computing network (e.g., LAN, WAN, Internet, etc.) to which user devices 104 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

To facilitate searching of the vast number of content sources 106 accessible over the network 102, the environment 100 can include a search system 107 that identifies the content sources 106 by crawling and indexing the content sources 106. Data about the content sources 106 can be indexed based on the content sources 106 with which the data is associated. The indexed and, optionally, cached copies of the resources 105 are stored in a search index (not shown). The search system 107 is configured to receive a query and generate a set of search results. The set of results may be generated based on the ranking of the search results. The advertisement system 108 may be configured to analyze the search results and the destination pages of the search results that may be generated by the search system 112.

In various illustrative implementations, an advertisement system 108 may be used to provide content to users at user devices 104. Advertisement system 108 may be configured to retrieve content to be presented from an advertisement database 110 to which advertisement system 108 is communicatively coupled (e.g., a local memory associated with advertisement system 108, a remotely accessible memory, etc.). In some implementations, advertisement system 108 may be configured to access advertisement database 110 through network 102 or another communications network. Advertisement system 108 may be configured to select advertisements to be presented to a particular user based on information associated with other users. For example, advertisement system 108 may be configured to determine content to present to a user based on the shared demographic information about the other user, a geographic location of the other user, interests of the other user, etc. The other users may opt-in or out-in of sharing data with other users. All user data may be anonymized to remove user identification information prior to any data being shared with the advertisement system 108. In this manner, the user may be more likely to be interested in the displayed content.

In some implementations, the demographic and/or other data may be obtained from a representation with which the user is interacting, such as a profile of the co-user on an online social network service. The co-user can choose to authorize the advertisement system 108 to access the co-user's profile. The co-user can choose to share a partial profile or a complete profile with the advertisement system 108. For example, the advertisement system 108 may access an online social network profile of the co-user that lists a birthday or birth year indicating that the co-user is 35 years old, and the content may be searched for and displayed for relevant products based on the profile information combined with co-user's online search activity or the co-user's gift list.

In some implementations, the data may be obtained from other data sources to which advertisement system 108 has access that the user may or may have interacted with in the past prior to searching for a gift for the co-user. For example, a user may be viewing an electronic message (e.g., a message on a social network) sent from a co-user or a friend of the co-user announcing a birthday party of the co-user, and advertisement system 108 may have access to information (e.g., publicly accessible information or with the authorization of the co-user) that the co-user has posted on an online social network service profile. Content may be presented to the user suggesting that the user buy certain products for the co-user's birthday to give the co-user as a present at the party, and the products to be advertised to the user may be selected based on information stored in the co-user's social media profile. In some implementations, the information that may be used to determine the appropriate content to present to the user may be limited to information about the co-user to which the user has access or information that the co-user has opted to share. For example, after the co-user chooses to share their profile information, the co-user's social media profile information may be used to determine the content to display to the user. The advertisement system 108 may be disallowed from using the social media profile information of the co-user, if the co-user has chosen to make the profile information or part of the profile information private and disallow access to the user. This helps preserve the privacy for the co-user for certain information that the co-user may wish to keep private to a certain group of friends or contacts (e.g., the co-user may not want any user outside that group to be able to observe any phenomena that depend on the information made private by the co-user).

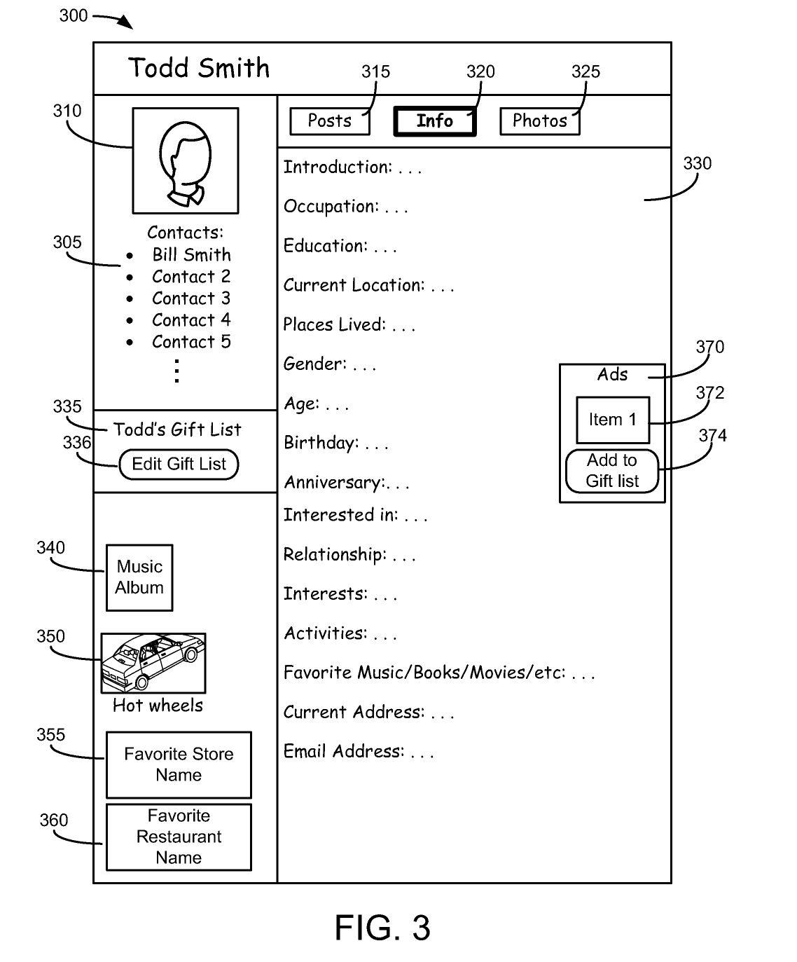

Users often use electronic devices connected to information resources such as the Internet to utilize the data relating to other users to determine a suitable gift for another user. For example, the advertisement system 108 may receive a gift request from a user about a co-user (i.e., another user) based on information posted on an online community profile of the co-user, posts authored by the co-user and posts using an account of the co-user on an online social network or messaging service, entries written by the co-user on a blog or message board, etc. The information about the co-user may include a wish list or gift list that a co-user has assembled and made accessible as shown in FIG. 3.

In some illustrative implementations, advertisement system 108 may be configured to identify and/or generate advertisements that suggest a gift for the user to purchase for the co-user. The gift may be based on an actual, perceived and/or potential relationship between the user and the co-user, such as friendship, family, etc. With respect to relationship each user or co-user may opt-in or opt-out of identifying another user as being in a relationship with each other. Each user has to approve or disapprove the sharing of information with any user. In some implementations, the content may be directed to a particular occasion that is specific to the co-user and/or the user, such as a birthday of the co-user, an anniversary of the co-user and/or the user, an event in the co-user's life such as a retirement or graduation, a party being held by or in honor of the co-user, etc.

In some implementations, advertisement system 108 may be configured to access a co-user's preferences regarding gifts (e.g. gift list or wish list) and serve content or advertisements based on the co-user's preferences to users that are connected via an online social network to the co-users. Displaying content based on the co-user's preferences may encourage the users to purchase the preferred gift for the co-user. In one embodiment, the content may identify the co-user to the user. For example, the content may display “Gift idea for [co-user name]”. The advertisement system 108 generates content to users that are connected to the co-user through an online community, or online social network.

In some implementations, advertisement system 108 may be configured to identify content to be displayed to a user based on the co-user's Internet activity or interactions with one or more other co-users. In some implementations, content presented to the user may include suggestions that the user buy an advertised product or service as a gift for the co-user or co-users, or add the product or service to a gift list data file or web page for the user's social or online contacts. The content may be identified or selected based at least in part on shared or un-shared characteristics of the co-user(s) and/or data relating to the interaction of the user with the co-user(s) (e.g., information relating to the relationship of the user with the co-user(s)). For example, in one illustrative implementation, the advertisement system 108 may determine content based on an online social network profile of a co-user, and content presented to the user may be based on an interest of the co-user listed in the co-user's profile. In another illustrative implementation, the advertisement system 108 may determine displayable content based on an online social network profile of a co-user, and the content presented to the user may be based on a message from the co-user announcing a party of the co-user, and the content presented to the user may suggest a relatively substantial gift when interaction data available to advertisement system 108 indicates that the user and the co-user are socially close (e.g., close friends, in a relationship, blood relation, etc.). In some implementations, the content may include suggestions for gifts for a special occasion relating to the co-user, such as a birthday, anniversary, or other occasion for which gifts may be customarily given.

In some implementations, advertisement system 108 may be configured to identify content to be presented to a user based on the user's online interaction with another co-user. In some illustrative implementations, the user may be having a two-way online interaction with a co-user (e.g., including text, audio, video, etc.), and content may be presented to the user based on the interaction or co-user's gift list or searches or other online activity. For example, the co-user may express that the co-user likes a particular type of product, and content may be presented to the user suggesting that the user purchase the product for the co-user as a gift. Users or co-users may opt in to such a service, or opt out of such a service at any time. In some illustrative implementations, the user may be playing an online game with the co-user, and content may be presented to the user suggesting that the user purchase a sequel to the game or a related game for the co-user and/or for himself.

In some illustrative implementations, advertisement system 108 may be configured to identify content to be presented to the user when the user informs the search system 112. For example, the advertisement system 108 may access a profile of the co-user on an online social network service, when a user has opted to share their information with the advertisement system 108, messages posted by the co-user on an online social network service, messaging service, message board, etc., access an electronic message received from the co-user, access an electronic message to the co-user, access text or media (e.g., photos) posted by the co-user on a blog or website, access photos (e.g., posted on an online social network service) in which the co-user is present (e.g., in which the co-user has been tagged), etc. The advertisement system 108 may anonymize the user's data so that the user is unidentifiable to the other users. A user may access another users information only when the user opts-in to share the information with another user or set of users. A user may always choose to opt-out of sharing information regarding themselves with other users.

In various illustrative implementations, advertisement system 108 may be configured to select and/or generate content for display to a user based on any or all of a variety of different types of data relating to the co-user(s), and/or gift list provided by the co-user(s). For example, in some implementations, content may be displayed based on demographic or other data relating to a co-user with whom the user has a connection based on an online social network. In various implementations, content may be displayed based on various types of demographic data, geographic location, etc. In various implementations, content may additionally or alternatively be determined based on various other types of data, such as relationship status, historical residence data, personal information posted by the co-user (e.g., in an online social network profile), interests and/or activities of the co-user, favorite music/movies/books/etc., and/or other types of data. Users may opt out of the use or storage of any of these types of demographic or other data.

In some implementations, advertisement system 108 may be configured to select content to be presented to the user based on data relating to both the user and the co-user. In some implementations, the data on which the content is based on may include demographic data of the user and co-user. For example, content for mittens may be presented to a first user when interacting with a profile of a second user with a birthday coming up within the next two weeks, where the second user's profile lists a cold region as his residence. In some implementations, the data on which the content is based on may include other data such as interest data of the user and co-user. For example, a profile of the user and a profile of the co-user may both indicate an interest in a particular sports team, and content presented to the user may be directed to memorabilia for that sports team. In some implementations, the data on which the content is based on may include the online searches performed by a co-user and determining a purchasable product that would be an appropriate gift for the co-user. The co-user may opt-in to share their online searches to help other users determine a gift for the user. The co-user can op-out of sharing any information regarding their searches at any time. In one embodiment, the co-user can indicate which users can see which searches. In another embodiment the co-user can remove certain searched from being shared with users. In one implementation, the online searches, performed by a co-user may be used after receiving a co-user's authorization. In some implementation, when using the online searches the purchasable product may be identified to the co-user and approval for the purchasable product as a gift may be received by the advertisement system 108.

In some implementations, advertisement system 108 may be configured to select content to be presented to the user based on a particular type of potential relationship (e.g., a friend relationship) identified based on characteristics of the user and the co-user. In one example, the user may be connected online with a co-user, and advertisement system 108 may determine that the user may be related to the co-user and present content that is appropriate for the relationship to the user. In another example, the advertisement system 108 may determine that the user purchased an item for a co-user based on a yearly or monthly purchasing patterns. Advertisement system 108 may be configured to consider any type of relationship in identifying content to present to a user, such as friends, significant others, family, professional contacts, classmates, etc. In one embodiment, the advertisement system 108 or the online social network may request that a user identify the relationship between the user and the co-user.

In some implementations, advertisement system 108 may be configured to consider an interaction history between the user and the co-user when identifying appropriate content for presentation to the user. For example, a measure of the amount of interaction between the user and the co-user may be used to identify appropriate content, such as a frequency of interaction of the user with the co-user online, how many different ways the user interacts with the co-user online, whether the co-user reciprocates by interacting with the user online, the number of e-mails, chats, etc. In an example related to the example in the above paragraph, advertisement system 108 may be configured to present content for a gift only if historical interaction data indicates that the user interacts frequently (e.g., above a predetermined frequency threshold) with a co-user. In some implementations, advertisement system 108 may be configured to consider whether the interaction is bi-directional in determining the content (e.g., a fraction, percentage, amount, etc. of messages that are followed by a reply or other type of interaction by the co-user exceeds a predetermined threshold). In one implementation, there may be no interaction between the user and the co-user prior to the content being displayed for the user.

In various implementations, the advertisement system 108 may determine items for the gift lists could be based on a co-user's past transaction information. Past transaction information could be extracted from various sources depending on available data sources that the co-user has opted-in to share with other users. For example the co-user can choose to share information from co-user's bank account, a digital wallet solution or a third-party database (e.g. Mint or Obopay) may be used to determine the amount of transactions that occurred at a merchant location. With respect to financial information the co-user can choose to share some or all information. In one embodiment, the co-user can choose to share merchant names and not the transaction amount or the product(s) that were purchased. To access co-user's account information the co-user could share their credentials with the advertisement system 108. Their advertisement system 108 can query the co-user's past transaction information to glean information that will infer the co-user's preferences so that a gift list can be automatically generated for that co-user. Transactions could be filtered (e.g. those relating to groceries are not likely to be relevant to gifts for the user, but those related to clothes are more likely to be relevant) and prioritized (if the co-user shops frequently in the same store, this is more likely to be a favorite for the co-user).

In some implementations, advertisement system 108 may be configured to identify content based on keywords appearing in a passage (e.g., a post) written by the co-user that is being viewed by the user. The keywords may be used to identify purchasable products that the co-user may want or the keyword may be the name of a purchasable product. In various examples, the user may be viewing various types of text written by the co-user, such as an online social network profile, posts on an online social network or messaging service, blog posts, websites, electronic communications/messages, real-time online communications, etc. Various keywords may be extracted from the text and used as a basis for determining content for products or services to be presented to the user. Users and co-users may opt in or opt out of this extraction of data. In order to enable the extraction of data the users may opt in. In one example, a user may be presented with content for a particular movie DVD when viewing a status message from a co-user talking or inquiring about the movie. In another example, a user may be presented with content for a tennis racquet or a gold club when viewing a recipient's message about a recently concluded tennis event or golf event. In yet another example, a user may be presented with content for concert tickets for The Greatest Band Ever when interacting in real-time online with a co-user about how much she enjoys this band. In some implementations, advertisement system 108 may be configured to identify content based on common or similar keywords appearing in text written by both the user and the co-user. For example, a user may be presented with content for a ski vacation when both the user and the co-user write messages about skiing on an online social network message board.

In some implementations, advertisement system 108 may be configured to identify content based on information extracted from media (e.g., photos, audio, video, etc.) relating to the co-user. For example, the co-user and/or the user may appear in a photo, video, audio file, etc. In one implementation, the geographical location of the photo, video, audio file, etc may be determined and used to determine the content to be displayed. In some implementations, the media may have an associated caption or other text from which the subject of the media, participants in the media, people appearing in the media, etc. can be determined for use in determining appropriate content based on the media. In some implementations, advertisement system 108 may be configured to utilize metadata (e.g., publicly accessible metadata) associated with the media to determine appropriate content. In some implementations, advertisement system 108 may be configured to analyze the media data itself (e.g., using a photo analysis application or algorithm, speech recognition application or algorithm, etc.) to determine keywords or subjects for use in determining appropriate content. For example, a user may post a photo of the Grand Canyon and tag himself and a co-user in relation to the photo, and advertisement system 108 may use a photo analysis algorithm to identify the photo as being a photo of the Grand Canyon and provide content for trips to other natural attractions. In another example, a user may listen to an audio file of a famous speech by a public figure posted by a co-user, and the user may be presented with content for biographical works featuring the public figure.

In some implementations, advertisement system 108 may be configured to identify content based on the geographical location of the co-user and/or the user. For example, advertisement system 108 may be configured to provide content for swimming trunks to a user if the co-user lives in a geographical area known for beaches or swimming pools. In another example, advertisement system 108 may be configured to provide content for pair discounts for event tickets (e.g., 2-for-1 tickets) to the user if the user and the co-user live within a geographical area of each other (i.e. within a drivable distance like 100 miles of one another). In some implementations, advertisement system 108 may be configured to consider the time of year and/or weather data when determining content based on location data. In some implementations, advertisement system 108 may be configured to identify content based on products and/or services that are relevant to a particular locale. For example, advertisement system 108 may be configured to recommend a surfboard to a user when seeking a gift for a co-user who lives on the coast of California but not when seeking a gift for a co-user who lives in Arizona, despite the fact that both are warm-weather locales, because the surfboard may be more useful for the California-based co-user. In various implementations, the location data may be obtained from the data or representation of the co-user with which the user is interacting or from some other data source available to advertisement system 108. In one implementation, the data source may be a data source connected to a search system 107.

In some implementations, advertisement system 108 may be configured to present content based upon a machine-learned classification of the user, the co-user, and/or a relationship between the user and co-user. For example, advertisement system 108 may be configured to display content based on certain characteristics of the user and/or co-user and/or based on keywords in a manner such as that described above with respect to various illustrative implementations. Advertisement system 108 may be configured to track a measure of effectiveness of the content presented to various users, such as by saving data relating to click-through rate or other measures of interaction of users with the provided content. The effectiveness data may indicate that a particular type or category of advertisement is most effective, for example, when the user and co-user are in the same general geographic location. Advertisement system 108 may be configured to identify subsequent content based in part on the effectiveness data to increase the effectiveness (e.g., click-through rate) of the content presented to users. In various embodiments, the effectiveness data may be global to all users, obtained from and/or applied to a particular group or category of users (e.g., based on demographic, geographic, interest, and/or other types of data), and/or obtained from and/or applied to a particular user and/or co-user (e.g., within a user and/or co-user profile stored in advertisement database 110).

In some implementations, advertisement system 108 may be configured to identify content based upon a measure of social proximity between the user and the co-user. Advertisement system 108 may utilize any or all of a variety of different measures to represent the social closeness or proximity between the user and the co-user. For example, in a social networking context, one measure of whether the user and co-user are socially close may be whether they are friends or contacts on the social network. Another example measure may be based on the number of social node hops between the user and the co-user (e.g., whether the user is a friend of the co-user, a friend of a friend of the co-user, a friend of a friend of a friend of the co-user, etc.). Another example measure may be based on how many friends the user and the co-user have in common. Yet another example measure may be based on how frequently the interactions are between the user and the co-user. Another example measure may be based on how often the user returns or responds to messages posted by the co-user and vice-versa.

In various implementations, advertisement system 108 may be configured to identify and/or generate content for presentation to the user based on a combination of two or more of the features described above. For example, content for a bottle of wine may be presented to a user when the user RSVP's “yes” to an online party invitation of the co-user and the co-user is among the top 20 closest contacts of the user according to at least one measure of social proximity. Various other combinations of features may be utilized in various illustrative implementations.

In some implementations, advertisement system 108 may be configured to select content for presentation to the user based on the interaction of the user with representations of two or more co-users. For example, the user may be viewing a photo tagging multiple co-users (e.g., a photo of a group of classmates or friends, a sports team, etc.) and content may be provided based on common interests between the group of friends, or an activity in which the group is participating in the photo. In another example, the user may be participating in a form of real-time online interaction with multiple co-users (e.g., text, voice, video, etc.). In some implementations, content presented to the user may be based on data relating to two or more of the co-users with whom the user is interacting.

In an alternative implementation, the advertisement system 108 could present content to other applications besides a web page, such as but not limited to, GPS maps, maps, video-delivery services, and social networking site. An improvement in the search results may be realized when there is a search for a gift for a specified user.

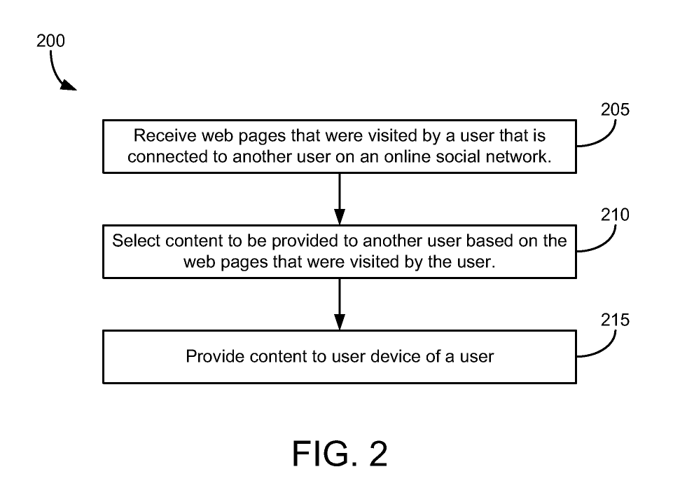

FIG. 2 illustrates a flow diagram of a process 200 for providing content based on the web pages that were visited by a first user that is connected to another user on an online social network. In some implementations, process 200 may be executed or carried out using one or more components of environment 100 (e.g., advertisement system 108, search system 112) illustrated in FIG. 1.

An advertisement system 108 may be configured to receive web pages that were visited by a user that is connected to another user on an online social network at block 205. The web pages may include search queries, results while the first user is logged into their online social networking web site. The web page may include online retailers where the first user viewed a product or placed a product on the cart. The web page may include a computer determined gift list that is generated based on an analysis of the web page. The first user can edit the computer determined gift list to add items or services or remove items or services.

The advertisement system 108 may be configured to select content to be provided to another user based on the web pages that were visited by the user at block 210. The advertisement system may be configured to identify appropriate content to present to the user based on one or more of a variety of different factors, such as demographic data for the co-user and/or user, interest data for the co-user and/or user, keywords included within internet searches of the co-user with which the user is connected, a measure of social proximity between the user and the co-user, and/or other factors. In some implementations, the content presented to the user may include suggestions for gifts from the user to the co-user. The selected content may be presented to the user at a user device at block 215.

Referring specifically to FIG. 3, an online social network profile image 300 for a co-user named Todd Smith is shown according to an illustrative implementation. Image 300 includes a contact list 305 of contacts of Todd Smith on the social network. The contact list includes, for example, Bill Smith and contacts 2-5 or more. Image 300 includes a profile photo 310 that Todd Smith may select as an identifying image for his profile. Image 300 may include navigation buttons that may be used to navigate to different portions of the social network data for Todd Smith, such as a posts button 315, an information button 320, and a photos button 325. In image 300, the information button 320 is active and the profile for Todd Smith is displayed.

Various types of profile data for Todd Smith may be displayed in a profile frame 330. The profile information may include various types of information about Todd Smith, such as an occupation, education information, a current location and/or previous residency locations, demographic information, interests and activities, particular music, books, movies, etc. in which Todd Smith is interested, contact information for Todd Smith (e.g., email and/or physical address), etc. In some implementations, profile frame 330 may include an introduction section in which Todd Smith may include a short narrative about himself.

Image 300 includes an example gift list 335 for Todd, the gift list 335 may include a label “Todd's gift list”. Included in gift list 335 is a selectable button 336 labeled “edit gift list”. If Todd chooses to edit the gift list 335, then Todd Smith may select the selectable button 336. When the user (Todd Smith) chooses to edit the gift list 335, the user may be presented with options to remove items from the gift list or add items to the gift list. In order for Todd to add items to the gift list 335, Todd may be offered a prompt to search for items.

The gift list 335 includes a plurality of items that have been added by Todd or the advertisement system 108 has included the items based on a determination that Todd may want those products based on the web pages that were visited by Todd. For example, music album 340 may be Todd's favorite music album as identified by Todd. Alternatively, the music album 340 may have been identified because Todd identified that Todd Smith owned another music album by the same artist or Todd Smith mentioned going to a concert for an artist of the music album. The gift list 335 includes other items such as, hot wheels 350, favorite store name 355 and favorite restaurant. In other implementations, the gift list 335 could store specific items that they would like such as a specific film, item of clothing in a particular size or color. In other implementations, the gift list 335 could store a genre of items, such as action movies, science fiction novels, summer clothing. The genres may be narrowed, such as but not limited to, music albums by a particular artist, specific range or crockery, or electronic equipment such as a tablet that has a certain specification (i.e. screen size >7 to 9 inches). The gift list 335 may list preferred brand names, quality of items, and types of items. In yet other implementations, the user or co-user could store information in the gift list relating to each of the categories mentioned above.

Image 300 may include an advertisement frame 370 configured to provide content recommending various products and/or services to Todd Smith or the viewer of Todd Smith's profile. The content to be displayed in advertisement frame 370 may be determined based on various data relating to Todd Smith or the user viewing Todd Smith's profile, data relating to a relationship between Todd Smith and the user, and/or information included in image 300. A first advertisement 372 for a “item 1” may be presented based on an identified characteristic from the profile frame 330 or other online activity of Todd Smith. In the proximity of the advertisement for “item 1” the system may generate a selectable button 374 “add to gift list”. If Todd Smith chooses to add item 1 to his wish list he may provide his gift list login credentials and select the selectable button 374.

In some implementations, the content may be related to a special occasion. For example, profile frame 330 may indicate that Todd Smith's birthday is approaching soon, and advertisement frame 335 may include one or more gift suggestions for the user to purchase for Todd Smith for his birthday. A special occasion may include an event that is infrequent in nature or periodic (e.g., monthly, bi-annual, annual, every 5 years, every 10 years, etc.), a one-time occurrence or event that occurs very few times, an event corresponding to a particular milestone or point of significance (e.g., graduation, wedding, etc.), a periodic event (e.g., birthday, anniversary), etc.

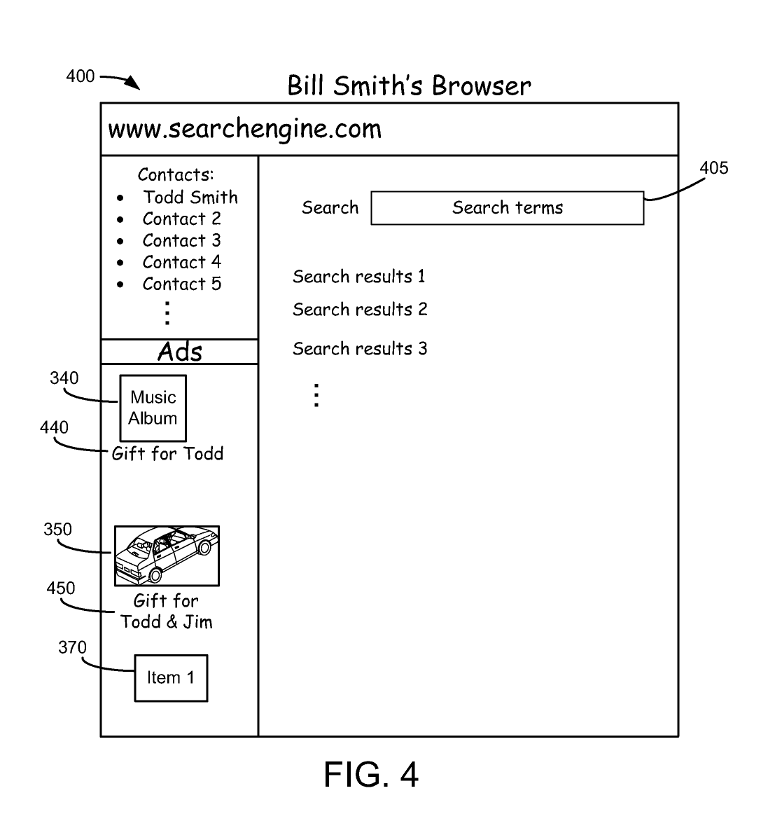

FIG. 4 illustrates a display image 400 that may be displayed on another user's browser (i.e. Bill Smith who is a contact or connected with Todd Smith). In the example shown in FIG. 4, Bill Smith's browser is at an example Universal Resource Locator (URL) “www.searchengine.com”. The URL in FIG. 4 is an example URL and it could be any other URL. At the search engine Bill Smith may be offered the choice of entering search terms at text box 405. Upon entering the search terms in text box 405, Bill Smith's browser may receive the search results 1, 2, 3, etc. from the search system 107. In some implementations, advertisements are also provided on a side panel 410 of Bill Smith's browser. The ads that are displayed on Bill Smith's browser are displayed on Bill Smith's browser because the ads related at least in part on Todd Smith's gift list. In another implementation, a user may search for gifts for a co-user by typing in the search terms, “Gifts for <username>”. The search system 107 may prompt the advertisement engine 108 to generate gift suggestions for the username that was entered during the search.

For example, the music album 340 was one of the items that was on the gift list 355 for Todd Smith. As shown from the contacts section Bill Smith has Todd Smith as one of his contacts. In one example implementation, the music album 340 is displayed with a message 440 that informs the user the reasons for the content being displayed. For example, the message 440 indicates to the user that the item being displayed may be a gift for Todd. In another implementation, the message 440 may indicate the occasion and identity of the co-user. In another example implementation if the same product or item such as, the hot wheels car 350 is on the gift lists of two different users (i.e. Todd and Jim), then the message 450 may inform the user that co-users Todd and Jim may like the hot wheels 350 as a gift.

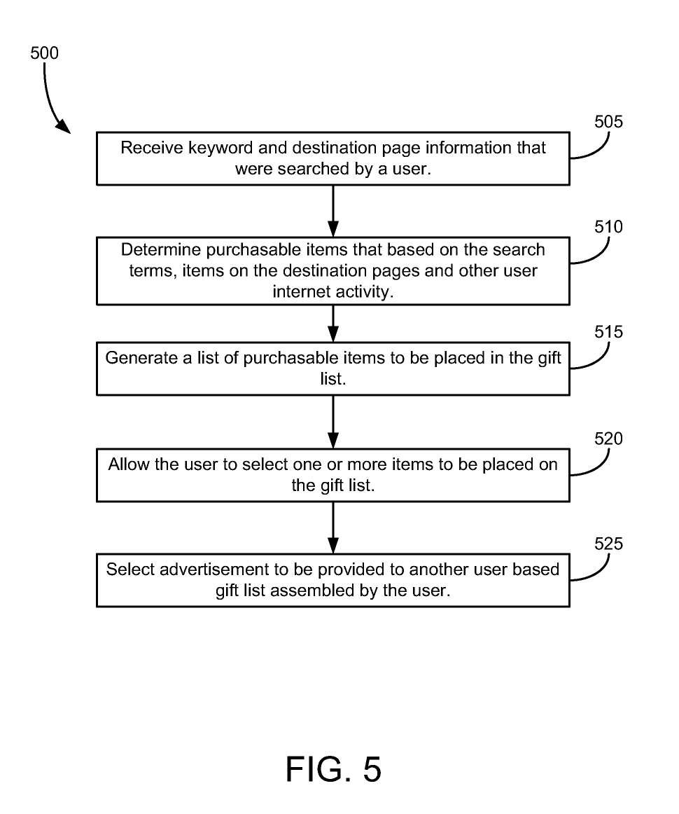

FIG. 5 is a flow diagram of a process 500 for determining the gift list for a user based on the searches performed by the user. The process 500 may also include analyzing each web page that is visited by a user to determine purchasable items that the user may want as a gift. The advertisement system 108 receives at least one keyboard and at least one destination page information that were searched by a user (505). Based on the destination pages the advertisement system 108 determines at least one purchasable item based on the search terms, items that are sold on the destination pages and other user Internet activities (510). The advertisement system 108 generates a list of purchasable items that may be placed in the gift list of a user (515). A ranking algorithm that ranks items in each destination page may rearrange the order of the list of purchasable items. The rank of each destination page in the search results may also be used to rearrange the order of the list of purchasable items. The search results may also have advertisements and/or content that are embedded within the search results page. The advertisement system 108 allows the user to select one or more items that may be placed on the user's gift list (520). The advertisement system may select content to be provided to another user based on the gift list that was assembled by the user (525).

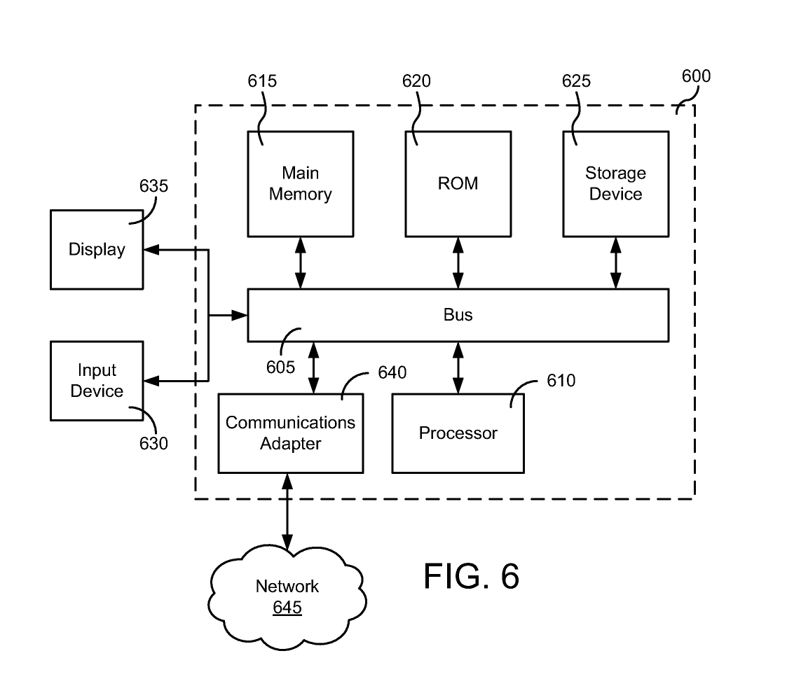

FIG. 6 illustrates a depiction of a computer system 600 that can be used, for example, to implement an illustrative user device 104, an illustrative advertisement system 108, an illustrative advertiser device 112, and/or various other illustrative systems that may be used in the implementation of an environment in which online advertisements may be provided as described in the present disclosure. The computing system 600 includes a bus 605 or other communication component for communicating information and a processor 610 coupled to the bus 605 for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 610 or other static storage device coupled to the bus 605 for storing static information and instructions for the processor 610. A storage device 625, such as a non-transitory, solid state device, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information, and command selections to the processor 610. In another implementation, the input device 630 has a touch screen display 635. The input device 630 can include a cursor control, such as a mouse, a trackball, or cursor direction keys, for communicating direction information and command selections to the processor 610 and for controlling cursor movement on the display 635.

In some implementations, the computing system 600 may include a communications adapter 640, such as a networking adapter. Communications adapter 640 may be coupled to bus 605 and may be configured to enable communications with a computing or communications network 645 and/or other computing systems. In various illustrative implementations, any type of networking configuration may be achieved using communications adapter 640, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to implement illustrative implementations. Thus, implementations are not limited to any specific combination of hardware circuitry and software.

Although an example processing system has been described in FIG. 6, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination in a single implementation. Conversely, various features that are described in the context of a single implementation can also be carried out in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
receiving, at an advertising system comprising at least one server computing system, web pages that were visited by a first user that is connected to a second user on an online social network;
determining, using the advertising system, an advertisement to be provided to a second user based on the web pages that were visited by the first user;
providing, using the advertising system, the advertisement for presentation to the second user.

2. The method of claim 1, further comprising determining, using the advertising system, at least one purchasable item based on the web pages that were visited by the first user; and
receiving approval from the first user that the at least one purchasable item is desirable as a gift prior to providing the advertisement for presentation to the second user.

3. The method of claim 1, wherein the web pages include a plurality of search results from at least one online search performed by the first user.

4. The method of claim 3, further comprising analyzing the search results that were generated based on the at least one online search performed by the first user.

5. The method of claim 4, wherein the analyzing search results comprises determining whether the destination page of each search result is an e-commerce site.

6. The method of claim 1, wherein the web pages comprises data relating to interaction of the first user with at least one of micro-blogging posts, status updates, and message board entries of the second user.

7. The method of claim 1, wherein the advertisement is determined based on the characteristics of the second user, and wherein the characteristics of the second user include only characteristics that are accessible to the first user.

8. The method of claim 1, wherein the advertisement is determined based on characteristics of the first user, and wherein the characteristics of the first user include a special occasion specific to the first user that occurs on one or more specific dates.

9. The method of claim 1, wherein the advertisement is based on characteristics of the first user, and wherein the characteristics of the first user include information regarding one or more interests of the first user posted on a messaging service profile of the first user.

10. The method of claim 1, wherein determining an advertisement comprises:
determining one or more keywords that was used by the first user to perform online searches, and
determining the advertisement based on the one or more keywords.

11. The method of claim 1, wherein the advertisement is determined based on a measure of social proximity between the first user and the second user, wherein the measure of social proximity represents an estimation of the social closeness of the first user and the second user based on a number of shared connections with the online social network.

12. A system comprising:
at least one computing device operably coupled to at least one memory and configured to:
receive web pages that were visited by a first user that has a relationship with a second user;
determine an advertisement to be provided to a second user based on the web pages that were visited by the first user; and
provide the advertisement for presentation to the second user.

13. The system of claim 12, wherein the at least one computing device is configured to:
determine at least one purchasable item based on the web pages that were visited by the first user; and
receive approval from the first user that the at least one purchasable item is desirable as a gift prior to providing the advertisement for presentation to the second user.

14. The system of claim 12, wherein the web pages include a plurality of search results from at least one online search performed by the first user.

15. The system of claim 14, wherein the at least one computing device is configured to analyze the search results that were generated based on the at least one online search performed by the first user.

16. The system of claim 15, wherein analyze the search results comprises determining whether the destination page of each search result is an e-commerce site.

17. The system of claim 12, wherein the web pages comprises data relating to interaction of the first user with at least one of micro-blogging posts, status updates, and message board entries of the second user.

18. The system of claim 12, wherein the at least one computing device is configured to determine the advertisement based on characteristics of the second user, and wherein the characteristics of the second user include a special occasion specific to the second user that occurs on one or more specific dates.

19. The system of claim 12, wherein the advertisement is determined based on the characteristics of the second user, and wherein the characteristics of the second user include only characteristics that are accessible to the first user.

20. The system of claim 12, wherein the advertisement is determined based on characteristics of the first user, and wherein the characteristics of the first user include a special occasion specific to the first user that occurs on one or more specific dates.

21.-26. (canceled)

27. A computer-readable storage medium having instructions stored thereon that,
when executed by a processor, cause the processor to perform operations comprising:
receiving, at an advertising system comprising at least one server computing system, web pages that were visited by a first user that is connected to a second user on an online social network;
determining, using the advertising system, an advertisement to be provided to a second user based on the web pages that were visited by the first user; and
providing, using the advertising system, the advertisement for presentation to the second user.

28. The computer-readable storage medium of claim 27, further comprising:
determining, using the advertising system, at least one purchasable item based on the web pages that were visited by the first user; and
receiving approval from the first user that the at least one purchasable item is desirable as a gift prior to providing the advertisement for presentation to the second user.

29. The computer-readable storage medium of claim 27, wherein the web pages include a plurality of search results from at least one online search performed by the first user;
further comprising analyzing the search results that were generated based on the at least one online search performed by the first user; and
wherein the analyzing search results comprises determining whether the destination page of each search result is an e-commerce site.

30. The computer-readable storage medium of claim 27, wherein the web pages comprises data relating to interaction of the first user with at least one of micro-blogging posts, status updates, and message board entries of the second user.

31. The computer-readable storage medium of claim 27, wherein the advertisement is determined based on the of the second user, and wherein the characteristics of the second user include only characteristics that are accessible to the first user.

32. The computer-readable storage medium of claim 27, wherein the advertisement is determined based on characteristics of the first user, and wherein the characteristics of the first user include a special occasion specific to the first user that occurs on one or more specific dates.

33. The computer-readable storage medium of claim 27, wherein the advertisement is based on characteristics of the first user, and wherein the characteristics of the first user include information regarding one or more interests of the first user posted on a messaging service profile of the first user.
